(19) United States
(12) Patent Application Publication
(10) Pub. No.: US 2004/0042756 A1
(43) Pub. Date: Mar. 4, 2004

(54) Optical fiber array, and circuit connection method using the optical fiber array

(76) Inventors: Yukihiro Yokomachi, Kanagawa (JP); Hiroyasu Toyooka, Kanagawa (JP)

Correspondence Address: MCDERMOTT WILL & EMERY, 600 13TH STREET, N.W., WASHINGTON, DC, 20005-3096, US

(21) Appl. No.: 10/451,278

(22) PCT Filed: Nov. 29, 2001
(86) PCT No.: PCT/JP01/10461

(30) Foreign Application Priority Data
Jan. 26, 2001 (JP) 2001-18325

(51) Int. Cl. G02B 6/00

(52) U.S. Cl. 385/137

(57) ABSTRACT

A circuit connection method using an optical fiber array capable of connecting the optical fiber array to an optical part through circuits, comprising the steps of preparing the optical fiber array having a marker visible from the upper or side surface of the optical fiber array disposed parallel with an optical fiber (1) while maintaining specified interval from the disposed position of the fiber (1), and aligning the position of the end face of the marker of the optical fiber array to a marker provided on the optical part, whereby, an operation allowing monitor light to be mutually transmitted between the core part of the optical fiber and the core part of an optical wave guiding passage can be performed easily by roughly matching the position of the core part of an optical fiber to the position of the core part of an optical wave guiding passage opposedly to each other as a preliminary stage for aligning operation.

### TECHNICAL FIELD

The present invention relates to an optical fiber array and coupling method using the same for easy coupling work with an optical device.

### BACKGROUND ART

An optical fiber array comprising a plurality of optical fibers arranged in parallel and fixed together to make one integral body with ends thereof being arranged in a plane has been used as the optical part for coupling a coated optical fiber with an optical device such as optical surface-mounted wave guides.

FIG. 3 illustrates a plan view of a coupling example using such optical fiber array. Notations described in FIG. 3 are as follows:

21 are optical fiber arrays (hereinafter “optical fiber array” is referred to as “OFA”),

22 are optical fibers,

23 are coated optical fibers,

24 are substrates for the optical fiber array (hereinafter “substrate for the optical fiber array” is referred to as “array substrate”),

25 is an optical device,

26 is optical waveguides, and

27 is a substrate for the optical device (hereinafter “substrate for the optical device” is referred to as “device substrate”).

The OFA 21 conventionally has been composed of optical fibers 22 arranged in parallel and fixed onto the array substrate 24 made of glass or ceramics, etc. in the state where the covering material is removed at an end portion of each of the coated optical fibers. After fixing the optical fibers onto the array substrate, an end surface of the array substrate 24 and an end surface of the optical fibers 22 have been polished in order to be positioned in the same plane.

Although there are various functions in the optical device 25, such as an optical coupler, an optical filter, and an optical isolator, most of the devices have a pattern of the optical waveguides 26 formed on the device substrate 27.

The end surface of the optical waveguides 26 normally has been positioned in the same plane of the end surface of the device substrate 27.

Moreover, there has been an optical device in which an optical fiber is used instead of the optical waveguides formed a pattern near the end portion of the substrate.

FIG. 3 illustrates a conventional coupling method with optical waveguides and an OFA.

In this example, each of the OFAs 21 is coupled with the optical device 25 at each end-surface of both sides of the device, respectively. Intervals of the optical fibers 22 of the OFA 21 at the end-surface and the optical waveguides 26 of the optical device 25 at the end-surface are precision-manufactured beforehand so that each of core-portions of the optical fibers and each of correspondent core-portions of the optical waveguides are aligned.

For coupling with the OFA 21 and the optical device 25, the positioning work, which is called “alignment work”, to align the core-portions of the optical fibers 22 of the OFA 21 and the optical waveguides 26 of the optical device 25 at the end-surfaces is necessary such that optical coupling loss is minimized.

When coupling, the position where coupling loss between the optical fibers and the waveguides is minimized is explored by observing optical coupling loss using a light source and a photo detector, while moving one of the stages on which the OFA and the optical device are fixed, respectively, at very short distances, up or down, and right or left, relatively to the other stage.

This operation of exploring the position of the minimum coupling loss is called the alignment work.

### DISCLOSURE OF THE INVENTION

Rough alignment with the core-portions of the optical fibers and the optical waveguides is required just before the alignment work.

If light does not transmit at all between the optical waveguides and the optical fibers because of inaccuracy of the alignment, the alignment work to determine the position of the minimum connection loss cannot be performed.

The optical fiber fixed on the substrate made of glass or ceramic in the OFA is not easily recognized visibly because of the transparency of the optical fiber.

Furthermore, it is more difficult to identify the position of the optical fiber core with the naked eye because of its fine diameter of 10 micrometers.

Therefore, in the past, it has been necessary to explore a position where light can be transmitted between both core-portions of the optical fibers and the optical waveguides, by assuming from the outer side of the OFA and the optical device in a trial and error method through relative-movement of the stages on which the OFA and the optical device are fixed, respectively.

Since the deviation of each distance between the side surface of the OFA or the optical device and the end positions of the cores of the optical fiber or the optical waveguides is generally several 10 micrometers, and the core diameters of the optical fibers or the optical waveguides are very fine, 3-10 micrometers, it normally takes several minutes to complete such preliminary work for aligning the OFA and the optical device so as to achieve transmission of monitoring light by trial and error.

The OFA and a coupling method using the OFA according to the present invention can facilitate the alignment between the cores of the optical fibers and the optical waveguides for enabling the transmission of the monitoring light as a preparatory step to coupling between the OFA and the optical wave guides.

The OFA of the present invention comprises optical fibers whose covering material is removed at an end portion of each of the coated optical fibers and which are placed in parallel and fixed on an array substrate made of glass or ceramic, and further comprises a marker which is placed in parallel and at a predetermined interval with the optical fibers on the array substrate and which can be recognized from an upper or side surface of the OFA with the naked eye.

In the coupling work with the optical device and the OFA, the end of the marker in the OFA and a mark provided on the optical device is aligned prior to precision alignment between the optical fibers of the OFA and the optical waveguides or optical fibers of the optical device.

Thus, the work for rough alignment described above with core-portions of the optical waveguides and the optical fibers is facilitated as a preparatory step to the alignment work to couple the OFA and the optical device.

Namely, simple positioning of the marker and the mark eliminate the need of trial and error exploration to find the position where monitoring light can be transmitted.

An OFA according to one embodiment of the present invention comprises:

optical fibers fixed to V-grooves (hereinafter the V-grooves are referred to as “fiber-grooves”) formed in parallel to each other on an array substrate;

a marker made of a linear substance, such as a carbon coated fiber, whose side surface is colored and which is fixed to a V-groove (hereinafter the V-groove is referred to as “marker-groove”) formed in parallel to the fiber-grooves on the same surface of the array substrate; and

a cover plate made of substantially transparent material and adhered to the optical fibers and the marker, pressing them so as to form one integral body with the array substrate.

Since the deviation of the intervals between the positions of the fibers and the marker can be made as precise as less than 1 micrometer in terms of a predetermined interval, and the marker can be easily recognized visibly from the upper or side surface of the OFA, the work to align the cores of the optical waveguides with the optical fibers so as to transmit light between them is easily carried out by positioning the marker by the naked eye to face the mark of the optical device, and then the alignment work can proceed immediately.

### BRIEF DESCRIPTION OF DRAWINGS

FIG. 1 illustrates an embodiment of an optical fiber array related to the present invention; and (A) is a front view, (B) is a plan view, and (C) is a side view of the optical fiber array of FIG. 1.

FIG. 2 is a plan view of an example of coupling with an OFA and an optical device related to the present invention.

FIG. 3 is a plan view of an example of conventional coupling with an OFA and an optical device.

### BEST MODE FOR CARRYING OUT THE INVENTION

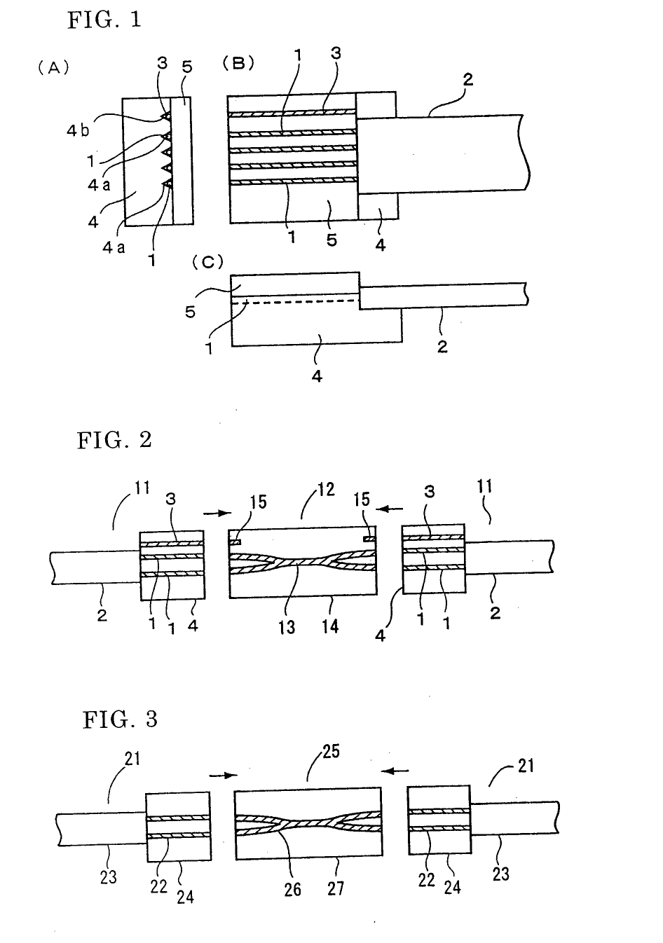

FIG. 1 illustrates an embodiment of an OFA of the present invention, FIG. 1 (A) is a front view, FIG. 1 (B) is a plan view, and FIG. 1 (C) is a side view.

Notations in FIG. 1 are as follows:

1 are optical fibers, 2 is an optical fiber cable, 3 is a linear substance (marker), 4 is an array substrate, 4a are fiber-grooves, 4b is a marker-groove, and 5 is a cover plate.

FIG. 1 illustrates an example of an OFA using a tape-shaped coated optical fiber cable 2 having a plurality of optical fibers 1. The optical fiber cable 2 has a plurality of optical fibers 1 placed in parallel to each other and covered with an integral coating.

In FIG. 1, the coating of the tape-shaped optical fiber cable 2 is removed at the end portion to expose the optical fibers 1, and each exposed portion of the optical fibers 1 is placed in one of the fiber-grooves 4a. The exposed portion of the optical fibers 1 are pressed by the cover plate 5, and fixed with adhesives on the array substrate.

The tape-shaped optical fiber cable 2 of the OFA may be replaced by a plurality of single-core optical fiber cables. The array substrate 4 is made of silicon or silica glass etc., and the fiber-grooves 4a and one marker-groove are provided in parallel to each other on the same surface of the array substrate 4.

The fiber-grooves 4a are normally arranged at the same interval; however, the interval between the marker-groove 4b and the fiber-grooves 4a may or may not be the same as those of the fiber-grooves 4a.

One of the fiber-grooves may be used as the marker-groove.

Thus the deviation of the interval between the optical fibers in the OFA and the linear substance (marker) can be fixed within 1 micrometer from the predetermined distance by using these V-grooves formed on the array substrate.

The marker of the present invention is described below.

If the marker is opaque from the view of the upper or side surface, does not cause any hindrance to polishing of an end of the OFA, and not discolored during the normal manufacturing of the OFA, such marker is applicable to the present invention.

For example, a silica linear substance having a color surface, a colored metallic rod or plastic linear substance, etc. are preferable for the marker of the present invention.

The so-called carbon-coated fiber, which is mainly made of silica glass and coated carbon on its surface, and having a carbon-coated surface, is especially preferable as a material for the marker.

The reason is as follows:

As its color is black, the position of its existence is clearly recognized.

As its linear thermal expansion coefficient is nearly the same as the array substrate and the optical fiber, the adhered state of the OFA is not affected by the change of outer thermal conditions.

Moreover, as the material of the marker is mainly silica, it is harmless during end polishing of the OFA.

The carbon-coated fiber is widely used for many applications and easily available without any special preparation for the marker. A substantially transparent material is used as the cover plate 5 in order to recognize the marker visibly from the upper or side surface of the OFA. The array substrate 4 does not require the use of a substantially transparent material. However, the array substrate 4 made of a transparent material is preferable, since the marker can be recognized visibly from the positions of both the upper and lower surfaces of the OFA.

After the optical fibers 1 and the linear substance 3 are placed on the fiber grooves and the marker-groove, respectively, and pressed by the cover plate 5 and fixed with adhesives etc., then the OFA of the present invention is polished such that all end-surfaces of the array substrate 4, the optical fibers 1, the linear substance 3 and the cover plate 5 are in the same plane.

The polishing plane may be perpendicular to the plane in which the optical fibers are placed in parallel; it may however be inclined about eight degrees to the perpendicular plane.

The linear substance 3 is not necessarily placed and fixed along the whole length of the marker-groove 4b; it is sufficient to be placed and fixed only nearby the end surface of the OFA.

In the above description, the linear substance 3 as a marker is placed at a predetermined interval in parallel to optical fibers of an OFA. However, the marker is not limited to such a case; it is sufficient if the marker can be visibly recognized and fixed within accuracy having a deviation of 10 micrometers or less from the predetermined position.

For example, if the marker-groove 4b on the array substrate 4 is directly painted, it can be used, without placing a linear substance, as a marker visibly recognized from the outside of the OFA.

The OFA manufactured by the above-described method is normally used for coupling with an optical device illustrated in FIG. 2. The notations in FIG. 2 are the same as those in FIG. 1 except the following additions:

11 is an OFA, 12 is an optical device, 13 is optical waveguides, and 15 is a mark.

Examples of optical devices to be coupled with the OFA of the present invention are an optical coupler, an optical filter, and an optical isolator and so on.

FIG. 2 illustrates an example of an optical coupler as an optical device 12.

The optical coupler has a layer formed normally by photolithography, as a predetermined pattern of optical waveguides 13, on the device substrate 14 and having a higher refractive coefficient than that of the substrate, and covered by a cladding layer.

The end-surfaces of the optical waveguides 13 are positioned both at end-faces of the optical coupler.

Marks 15 are provided at a predetermined distance from the end positions of the optical waveguides 13 of the optical device 12 for the purpose of improving the efficiency of coupling work with the OFA of the present invention.

The marks 15 are formed by photolithography in the same manner as the optical waveguides.

As the cladding layer of the optical device 12 is normally transparent, the colored mark can be visibly recognized from the surface of the optical device.

Since the optical device 12 is supposed to be coupled with the OFA 11, the intervals of the optical waveguides at an end-face are manufactured so as to coincide precisely with the intervals of the optical fibers 1 of the OFA 11 at the end-surface.

Moreover, the distance between the optical waveguides 13 and the mark 15 at the end-face thereof is also made so as to coincide precisely with the distance between the optical fibers 1 of the OFA 11 and the linear substance 3 at the end-face thereof.

In the case of coupling between the optical device 12 and the OFA 11, the OFA 11 and the optical device 12 are mounted respectively on stages being movable along the X, Y, and Z axes, and the preliminary work of aligning the end of the linear substance 13 and the mark 15 is carried out by moving the stages while observing both ends of the OFA 11 and the optical device 12 under a microscope.

This work allows the ends of the optical fibers 1 of the OFA 11 and the wave guides 13 of the optical device 12 to face each other, and monitoring light can be transmitted between the optical fibers 1 and the waveguides 13.

Moreover, the work for manual positioning under the microscope can be replaced with automatic positioning by processing images observed by the microscope.

Following this, the so-called alignment work for finding the position where the coupling loss is minimum is performed by very small relative movement of the stage on which the OFA 11 or the optical device 12 are mounted, while observing the coupling loss by an optical transmitter and a photo-detector connected to the other ends of the optical fibers 1 and the waveguides 13, respectively.

In the coupling method of the present invention, an end of the linear substance 13 of the OFA 11 first faces an end of the mark 15, so the position of the marker must be visibly recognized clearly from the outside of the OFA 13.

The linear substance 13 may have the same diameter as the optical fibers 1. However, if the diameter of the linear substance 13 is less than that of the optical fibers 1, the central position of the marker 13 can be visibly recognized more clearly.

The optical coupler in which the optical waveguides are provided on the device substrate is described above as an example of the optical device in reference to FIG. 2. However, there are cases where an optical device is not such a single-functioned device but is made of plural parts assembled together.

In such a case, the coupling position of the optical device where the optical fibers of the OFA are coupled is not limited to the end of the optical waveguides. An end of optical fiber fixed to the optical device, which is similar to the end of the optical fibers of the OFA, may be used as a coupling end of the optical device.

Moreover, the OFA is coupled with another OFA in some cases.

Even in such a case, the alignment work of the OFA with an optical device under a microscope as a step to prepare for the alignment work can be made by providing a mark at the position where the marker of the OFA of the present invention is to face at coupling.

### INDUSTRIAL APPLICABILITY

The OFA of the present invention comprises optical fibers arranged in parallel each other and fixed to an array substrate, and a visible marker which can be recognized from an upper or side surface of the OFA and which is provided in parallel to the optical fibers a predetermined interval.

The OFA of the present invention can reduce working hours for the aligning work by simplifying the operation for the preliminary alignment under a microscope so as to cause an end of the marker provided on the OFA and a mark provided on the optical device to face each other such that the monitoring light can be transmitted between the cores of the optical fibers and the optical waveguides, when coupling an optical device and the OFA.

Moreover, if a linear substance, such as a carbon-coated fiber, is used as the marker, and

the carbon-coated fiber is placed on a marker-groove arranged in parallel with fiber-grooves on the same surface of an array substrate, and

the optical fibers and the linear substance are pressed by a substantially transparent cover plate and fixed together to form one integral body,

then an OFA can be manufactured with precision such that a deviation of an interval between the optical fibers and the linear substance is within less than or equal to 1 micrometer in terms of the desired interval thereof, and the linear substance can be recognized clearly from an upper or side surface of the OFA.

Since the material of the carbon-coated fiber is similar to the optical fiber, the end-surface of the OFA can easily be polished.

Moreover, if the outer diameter of the linear substance is smaller than that of the optical fibers, the exact center position of the linear substance can be more easily ascertained, and the accuracy of the preliminary alignment can be improved further.

1. An optical fiber array comprising:
a plurality of optical fibers being arranged in parallel and fixed to an array substrate, the optical fibers being exposed by removing covering material at each end portion thereof; and
a marker provided in parallel to the optical fibers at a predetermined interval, the marker being recognizable with the naked eye from an upper or side surface of the optical fiber array.

2. An optical fiber array according to claim 1, wherein:
the optical fibers are placed on fiber-grooves, the fiber-grooves being formed in parallel to each other on a surface of the array-substrate;
the marker is a colored linear substance fixed to a marker-groove, the marker-groove being formed in parallel with the fiber-grooves on the same surface of the array-substrate; and
the optical fibers and the marker are covered with a substantially transparent cover plate so as to be adhered to the array-substrate.

3. An optical fiber array according to claim 2, wherein the linear substance is a carbon-coated silica-based optical fiber.

4. An optical fiber array according to any one of claim 2 or 3, wherein the outside diameter of the linear substance is less than or equal to the outside diameter of the optical fibers.

5. A method for coupling an optical fiber array to an optical device,
the optical fiber array comprising a plurality of optical fibers and a marker, the optical fibers being exposed by removing covering material at each end portion thereof and arranged in parallel to each other and fixed to an array substrate, the marker being placed in parallel to the optical fibers at a predetermined interval and recognizable with the naked eye from an upper or side surface of the optical fiber array,
the optical device being provided optical waveguides or optical fibers thereon,
the method including a step of preliminary alignment an end of the marker and a mark prior to alignment work for coupling the optical fiber array with the optical device.
